(19) United States
(12) Patent Application Publication
(10) Pub. No.: US 2012/0269267 A1
(43) Pub. Date: Oct. 25, 2012

(54) METHOD AND APPARATUS FOR UNIFIED SCALABLE VIDEO ENCODING FOR MULTI-VIEW VIDEO AND METHOD AND APPARATUS FOR UNIFIED SCALABLE VIDEO DECODING FOR MULTI-VIEW VIDEO

(75) Inventors: Byeong-doo CHOI, Siheung-si (KR); Seung-soo JEONG, Seoul (KR); Dae-sung CHO, Seoul (KR); Woong-il CHOI, Onsan-si (KR)

(73) Assignee: SAMSUNG ELECTRONICS CO., LTD., Suwon-si (KR)

(21) Appl. No.: 13/451,001

(22) Filed: Apr. 19, 2012

(30) Foreign Application Priority Data
Apr. 19, 2011 (KR) 10-2011-0036378

(51) Int. Cl. H04N 7/32

(52) U.S. Cl. 375/240.13; 375/E07.243

(57) ABSTRACT

Methods for scalable video encoding and decoding for a multi-view video and apparatuses for scalable video encoding and decoding which implement the methods are provided. At least one root image and other remaining images of an image sequence of a video are classified into a plurality of layers. At least one reference image relating to a current image of the image sequence is generated by using a parent image of the current image based on a reference image conversion technique for scalable prediction encoding. Prediction encoding may be performed with respect to the current image by using the at least one reference image.

### CROSS-REFERENCE TO RELATED APPLICATIONS

This application claims priority from Korean Patent Application No. 10-2011-0036378, filed on Apr. 19, 2011, in the Korean Intellectual Property Office, the disclosure of which is incorporated herein by reference in its entirety.

### BACKGROUND

1. Field

The present disclosure relates to methods for scalable video encoding and decoding for a multi-view video, and apparatuses for scalable video encoding and decoding which implement the corresponding methods.

2. Description of the Related Art

Communication techniques for application with respect to video content, such as peer-to-peer (P2P), near field communication (NFC), or the like, have been generalized in conjunction with the activation of the three-dimensional (3D) multimedia sector using 3D video content.

In order for 3D multimedia devices having various resolutions to share 3D video content, transmission of 3D video content of various formats is required. However, the multiview video coding (MVC) standard, which is the current communication standard for 3D video transmission, presently supports only one stereoscopic video stream, and therefore, a 3D video service based on the MVC standard cannot provide structural support for 3D video services of various formats.

### SUMMARY

Provided are methods and apparatuses for effective, unified scalable encoding capable of implementing intra-layer encoding and inter-layer encoding while hierarchically encoding various formats of video which constitute multiview video, and methods and apparatuses for scalable decoding.

Additional aspects will be set forth in part in the description which follows and, in part, will be apparent from the description, or may be learned by practice of the exemplary embodiments disclosed herein.

According to an aspect of one or more exemplary embodiments, a method for scalable video encoding includes: classifying at least one root image and other remaining images of an image sequence of a video into a plurality of layers; generating at least one reference image with respect to a current image of the image sequence by applying a reference image conversion technique for scalable prediction encoding which includes intra-layer prediction and inter-layer prediction to a parent image of the current image; and performing prediction encoding with respect to the current image by using the at least one reference image.

The method for video layer encoding may further include encoding parent image index information which indicates a respective parent image referred to by each of the images of the image sequence based on a tree structure according to a reference relationship relating to the image sequence.

According to another aspect of one or more exemplary embodiments, a method for scalable video decoding includes: extracting data from a bit stream of a video in which data at least one root image and other remaining images of an image sequence of the video are classified into a plurality of layers and encoded; converting a parent image from among restoration images of the image sequence into at least one reference image with respect to a current image by applying a reference image conversion technique for scalable prediction decoding which includes intra-layer prediction and inter-layer prediction to the parent image; and performing prediction decoding with respect to the current image by using the at least one reference image.

In the method for scalable video decoding, parent image index information which indicates the corresponding parent image referred to by each respective one of the images of the image sequence may be extracted from the bit stream.

According to another aspect of one or more exemplary embodiments, an apparatus for scalable video encoding includes: a layer classification unit which classifies at least one root image and other remaining images of an image sequence of a video into a plurality of layers; a reference image generation unit which generates at least one reference image with respect to a current image of the image sequence by applying a reference image conversion technique for scalable prediction encoding which includes intra-layer prediction and inter-layer prediction to a parent image of the current image; a prediction encoding unit which performs prediction encoding with respect to the current image by using the at least one reference image; and an output unit which performs transformation, quantization, and entropy encoding on data relating to the encoded current image, and which outputs an encoded bit stream and parent image index information which indicates the parent image of the current image.

According to another aspect of one or more exemplary embodiments, an apparatus for scalable video decoding includes: an extraction unit which extracts data from a bit stream of a video in which data at least one root image and other remaining images of an image sequence of the video are classified into a plurality of layers and encoded; a decoding unit which decodes the extracted encoded data and which outputs residual information and reference information relating to the image sequence; a reference image conversion unit which converts a parent image from among restoration images of the image sequence into at least one reference image with respect to a current image by applying a reference image conversion technique for scalable prediction decoding which includes intra-layer prediction and inter-layer prediction to the parent image; and a restoration unit which performs prediction decoding with respect to the current image by using the at least one reference image and the outputted reference information and the outputted residual information.

One or more exemplary embodiments include a non-transitory computer-readable recording medium which includes a program for implementing a method for scalable video encoding, according to one or more exemplary embodiments, by a computer. One or more exemplary embodiments may include a non-transitory computer-readable recording medium which includes a program for implementing a method for scalable video decoding, according to one or more exemplary embodiments, by a computer.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a schematic block diagram of an apparatus for scalable video encoding, according to an exemplary embodiment.

FIG. 2 is a schematic block diagram of an apparatus for scalable video decoding according to an exemplary embodiment.

FIG. 3 shows an exemplary inter-layer prediction structure for use in scalable video encoding and decoding, according to one or more exemplary embodiments.

FIG. 4 shows an exemplary image matrix of an image sequence of a video, according to an exemplary embodiment.

FIG. 5 shows an exemplary tree structure according to a reference relationship relating to an image sequence, according to an exemplary embodiment.

FIG. 6 illustrates a reference image conversion technique for use in performing inter-layer prediction with respect to an image sequence, according to an exemplary embodiment.

FIG. 7 illustrates an exemplary configuration of a reference image list, according to an exemplary embodiment.

FIG. 8 illustrates a layer structure of a stereo video which is configured for use in conjunction with an apparatus for scalable video encoding, according to an exemplary embodiment.

FIG. 9 shows a layer structure of a multiview video which is configured for use in conjunction with an apparatus for scalable video encoding, according to an exemplary embodiment.

FIG. 10 illustrates an incorporation of a multiview video coding (MVC) scheme and an MPEG frame compatible (MFC) scheme by an apparatus for scalable video encoding and decoding, according to an exemplary embodiment.

FIG. 11 is a flowchart which illustrates a process to be performed by using an apparatus for scalable video encoding, according to an exemplary embodiment.

FIG. 12 is a flowchart which illustrates a process to be performed by using an apparatus for scalable video decoding, according to an exemplary embodiment.

### DETAILED DESCRIPTION

Reference will now be made in detail to exemplary embodiments, examples of which are illustrated in the accompanying drawings, wherein like reference numerals refer to the like elements throughout. In this regard, the present exemplary embodiments may have different forms and should not be construed as being limited to the descriptions set forth herein. Accordingly, the exemplary embodiments are merely described below, by referring to the figures, to describe aspects of the present specification.

Hereinafter, various exemplary embodiments of methods and apparatuses for scalable video encoding and methods and apparatuses for scalable video decoding which implement technical features in accordance with the present inventive concept will be described in detail with reference to FIGS. 1 to 12.

FIG. 1 is a schematic block diagram of an apparatus for scalable video encoding (or a scalable video encoding apparatus), according to an exemplary embodiment.

A scalable video encoding apparatus 100, according to an exemplary embodiment, includes a layer classification unit 110, a reference image generation unit 120, a prediction encoding unit 130, and an output unit 140. An image sequence of a two-dimensional (2D) video, a three-dimensional (3D) video, a multiview video, or the like, may be used as an input to the scalable video encoding apparatus 100.

The layer classification unit 110, according to an exemplary embodiment, classifies images of an image sequence of a video into a plurality of layers. With respect to the images of the image sequence, which includes at least one root image, which are inputted into the scalable video encoding apparatus 100, the layer classification unit 110 may classify the at least one root image and the other remaining images by layer based on at least one image characteristic. For example, when the input video is a multiview video, the layer classification unit 110 may classify the images based on view.

Further, the layer classification unit 110 may set two or more classification conditions for classifying the images, i.e., the layer classification unit may classify the images based on two or more image characteristics. Thus, for example, when the input video is a multiview video, the layer classification unit 110 may classify the input images based on view and resolution.

The scalable video encoding apparatus 100, according to an exemplary embodiment, may perform scalable prediction encoding by using one or both of intra-layer prediction and inter-layer prediction. The reference image generation unit 120, according to an exemplary embodiment, may convert a parent image of a current image of the image sequence by applying a reference image conversion technique for scalable prediction encoding to generate at least one reference image relating to the current image. A single parent image which is also a reference image relating to the current image may be used in conjunction with the reference image conversion technique to generate a plurality of reference images. The parent image may be an image of a different layer with respect to the current image, or may be a different image of the same layer as the current image.

The reference image conversion technique, according to an exemplary embodiment, may include at least one of a bypass technique, a scaling technique, an interlaced-progressive conversion technique, a color conversion technique, a filtering technique, a warping technique, a weight adding technique, and an inter-layer interpolation technique. Thus, the reference image generation unit 120 may apply one or more reference image conversion techniques to a parent image to generate one or more reference images for the current image.

The prediction encoding unit 130, according to an exemplary embodiment, performs prediction encoding on the current image by using at least one reference image which has been generated by the reference image generation unit 120.

When performing prediction encoding with respect to the current image, the prediction encoding unit 130 may determine in advance whether to predict the current image with reference to any one of a restoration image of the parent image and reference information. The reference information may include, for example, one or more of motion information according to prediction, prediction mode information, reference index information, and the like. Thus, the prediction encoding unit 130 may perform prediction encoding with respect to the current image with reference to one of a restoration image of the parent image and the reference information.

With respect to the current image, the reference image generation unit 120 may generate a reference image list which includes at least one reference image which has been generated by using the reference image conversion technique. In particular, the prediction encoding unit 130 may perform prediction encoding with respect to the current image with reference to at least one image stored in the reference image list. Because the reference image to be included in the reference image list may vary based on variations relating to a present selection of the current image, the corresponding parent image, and the selected reference conversion technique, the scalable video encoding apparatus 100 may include a reference image list updating unit which updates and manages the reference image list.

The output unit 140, according to an exemplary embodiment, may perform transformation, quantization, and entropy encoding on the data outputted by the prediction encoding unit 130 to output an encoded bit stream. Further, the output unit 140 may output parent image index information which indicates a corresponding parent image for each respective one of the images of the image sequence, in conjunction with the encoded bit stream of the image sequence, based on a tree structure according to a reference relationship relating to the image sequence.

Still further, the output unit 140 may encode information which indicates the corresponding parent image with respect to the current image and information which indicates whether to refer to any one of the restoration image of the parent image and the reference image based on a tree structure according to a reference prediction relationship which exists between the current image and the parent image, and output the encoded information in conjunction with the encoded bit stream of the image sequence.

In addition, the output unit 140 may encode information which indicates the reference image conversion technique being used for prediction encoding, and output the encoded information in conjunction with the encoded bit stream of the image sequence. According to an exemplary embodiment, information relating to the reference image conversion technique, which has been used for generating a corresponding reference image of a current image, may be encoded and transmitted.

According to an exemplary embodiment, the parent image index information relating to the current image, information indicating which of the restoration image of the parent image and reference image is referred to by the current image, and the information indicating the reference image conversion technique being used may be inserted into a header of a transmission bit stream by the output unit 140.

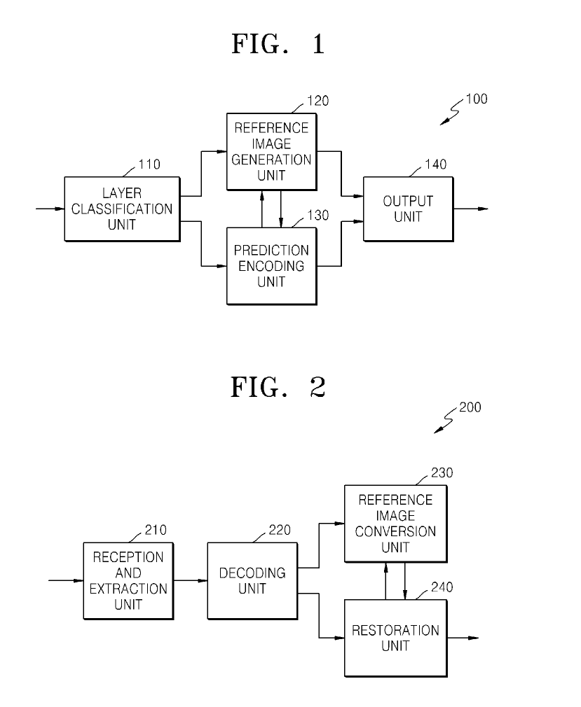

FIG. 2 is a schematic block diagram of an apparatus for scalable video decoding (or a scalable video decoding apparatus), according to an exemplary embodiment.

A scalable video decoding apparatus 200, according to an exemplary embodiment, includes a reception and extraction unit 210, a decoding unit 220, a reference image conversion unit 230, and a restoration unit 240.

The reception and extraction unit 210, according to an exemplary embodiment, may receive an encoded bit stream of a video which includes a 2D video, a 3D video, or a multiview video. The bit stream received by the reception and extraction unit 210 may include data in which images, including at least one root image of an image sequence of a video, have been classified into a plurality of layers and encoded.

The reception and extraction unit 210 may parse the received bit stream to extract the data in which the images have been encoded by layer. For example, the reception and extraction unit 210 may extract a bit stream which has been encoded by layer based on a view and a resolution from a bit stream of a multiview video.

The decoding unit 220, according to an exemplary embodiment, may decode the encoded data of the image sequence which has been extracted from the bit stream by the reception and extraction unit 210, and output residual information and reference information relating to the image sequence. The decoding unit 220 may perform entropy decoding, dequantization, and inverse transformation on the encoded data extracted from the bit stream to restore the residual information and reference information relating to the images.

The reference image conversion unit 230, according to an exemplary embodiment, may convert the parent image from among the restoration images of the image sequence into at least one reference image with respect to the current image. The restoration unit 240, according to an exemplary embodiment, may perform prediction decoding with respect to the current image by using the at least one reference image which has been generated by the reference image conversion unit 230 and the prediction information and residual information relating to the current image which has been outputted by the decoding unit 220 to generate a restoration image of the current image.

The restoration unit 240 may perform prediction decoding with respect to the image sequence to generate a restoration image of the video. The reference image conversion unit 230 may search for a corresponding parent image of each of the respective current images from among restoration images of a previous image which has been restored by the restoration unit 240, and then apply the reference image conversion technique to the parent image to generate a reference image of the current image.

The reception and extraction unit 210, according to an exemplary embodiment, may extract parent image index information from the parsed bit stream. In this case, the reference image conversion unit 230 may analyze a tree structure according to a reference relationship relating to the image sequence based on the extracted parent image index information and search for a parent image to which the current image may refer from among the already restored restoration images of the image sequence.

The reception and extraction unit 210, according to an exemplary embodiment, may extract reference subject information which indicates whether or not any one of the restoration image of the parent image and the reference information is to be referred to for prediction decoding with respect to the current image. In this case, the restoration unit 240, according to an exemplary embodiment, may determine whether or not one of the restoration image of the parent image and the reference image is to be referred to based on the reference subject information, and perform prediction decoding with respect to the current image with reference to the determined image to be referred to, and then accordingly generate a restoration image.

The reference image conversion unit 230 may convert one parent image into at least one reference image relating to the current image by using the reference image conversion technique, which includes at least one of a bypass technique, a scaling technique, an interlaced-progressive conversion technique, a color conversion technique, a filtering technique, a warping technique, a weight adding technique, and an inter-layer interpolation technique.

The reference image conversion unit 230 may generate a reference image list which includes at least one reference image generated by using the reference image conversion technique with respect to the current image. In this case, the restoration unit 240 may perform prediction decoding with respect to the current image with reference to at least one image stored in the reference image list, and output a restoration image.

The reference image conversion unit 230 may update and manage the reference image list based on a selection of a new current image, a determination of a corresponding new parent image with respect to the selected new current image, and an application of the reference image conversion technique to the corresponding new parent image.

The reception and extraction unit 210, according to an exemplary embodiment, may extract reference image conversion technique information from the parsed bit stream. In this case, the reference image conversion unit 230 may generate at least one reference image for the current image from one parent image of the current image based on the reference image conversion technique information.

The scalable video encoding apparatus 100 according to an exemplary embodiment and the scalable video decoding apparatus 200 according to an exemplary embodiment may respectively encode and decode a multiview video, as well as a 2D video and a 3D video, into separate layers in every view. Further, although videos may have the same view, the scalable video encoding apparatus 100 according to an exemplary embodiment and the scalable video decoding apparatus 200 according to an exemplary embodiment may respectively encode and decode the videos of different resolutions into separate layers. Still further, the scalable video encoding apparatus 100 according to an exemplary embodiment and the scalable video decoding apparatus 200 according to an exemplary embodiment may support inter-layer prediction of different layers as well as intra-layer prediction of the same layer, thus effectively reducing a transmission bit rate.

The scalable video encoding apparatus 100 according to an exemplary embodiment and the scalable video decoding apparatus 200 according to an exemplary embodiment can simultaneously implement multiview video encoding and decoding conforming to the MVC standard and hierarchical video encoding and decoding conforming to the SVC communication standard, thus providing a video communication service in which multiview videos of various formats are transmitted and received according to a unified video encoding and decoding scheme.

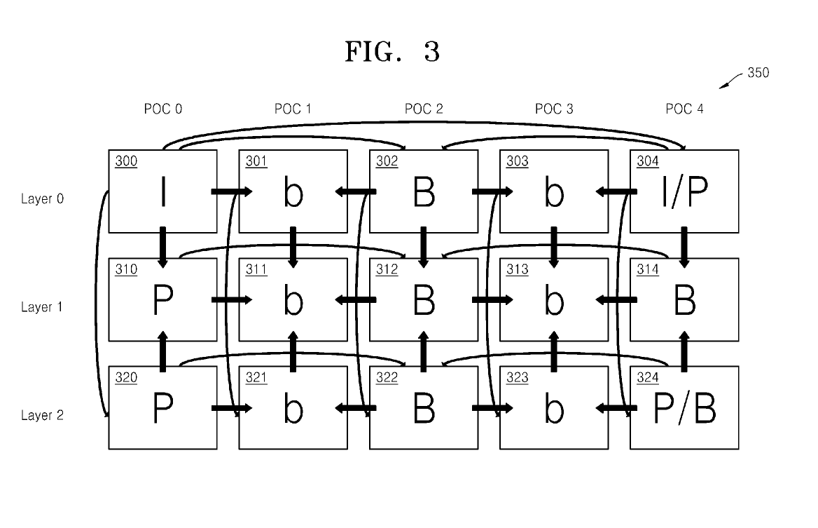

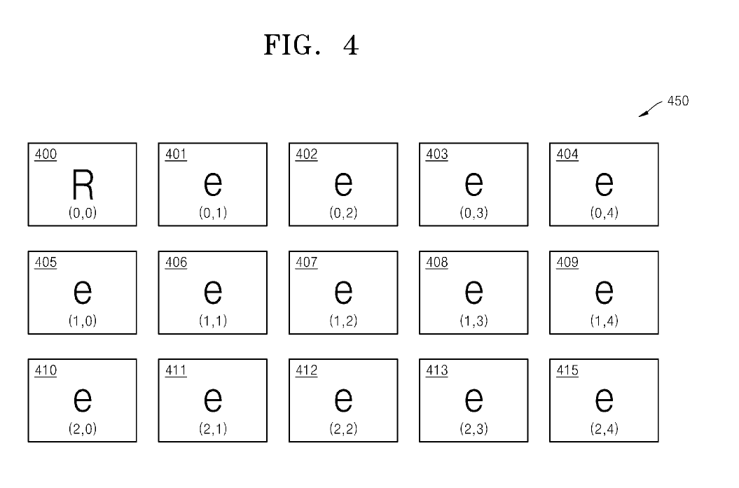

FIG. 3 shows an exemplary inter-layer prediction structure for use in scalable video encoding and decoding, according to one or more exemplary embodiments.

According to a scalable video encoding and decoding scheme, group of pictures (GOP) of a video are allocated as separate layers and inter-layer prediction can be performed, such that prediction encoding and prediction decoding may be performed with reference to mutually different GOPs.

In particular, among some pictures 350 included in an input video, 0^{th} GOPs of pictures 300, 301, 302, 303, and 304, first GOPs of pictures 310, 311, 312, 313, and 314, and second GOPs of pictures 320, 321, 322, 323, and 324 may be allocated as layer 0, layer 1, and layer 2, respectively.

An intra-coded picture 300, hereinafter referred to as an “I picture” 300 is a root picture or an instantaneous decoding refresh (IDR) picture, which becomes a reference image for inter-layer prediction between the bidirectionally predicted (hereinafter referred to as “b” or “B”) b picture 301 and the predicted (hereinafter referred to as “P”) P picture 320 of different layers, as well as a reference image of the B picture 302, the b picture 301, and the P picture 304 of same layers according to prediction encoding. Further, in general, in forward prediction, only a previous picture is referred to in a picture order count (POC) order in single layer prediction, while forward prediction may be performed on the P pictures 304, 320, and 324 which are available for inter-layer prediction with reference to previous pictures in the POC order of the same layer and same-ordered or previous pictures in the POC order but in different layers. Bi-directional prediction, which may refer to previous pictures and next pictures in terms of the POC order of the same layer, is performed on the B pictures 302, 312, 322, and 314, and b pictures 301, 311, 321, 303, 313, and 323, and prediction encoding referring to pictures in the same POC order of different layers may also be performed.

The scalable video encoding apparatus 100 according to an exemplary embodiment and the scalable video decoding apparatus 200 according to an exemplary embodiment may classify a 2D video, a 3D video, or a multiview video into a plurality of layers based on one or more particular image characteristics, and use inter-layer prediction as well as intra-layer prediction by employing a prediction structure relating to scalable video encoding and decoding schemes, such as the exemplary prediction structure illustrated in FIG. 3.

FIG. 4 shows an exemplary image matrix of an image sequence of a video, according to an exemplary embodiment.

First, the scalable video encoding apparatus 100 according to an exemplary embodiment and the scalable video decoding apparatus 200 according to an exemplary embodiment may be used to provide image indexing which indicates each of the images of an image sequence of a video in order to classify layers without restricting a layer classification condition upon which the scalable video encoding and decoding is to be performed, and manage a free reference relationship between images regardless of layers.

Image indexing, according to an exemplary embodiment, follows a 2D indexing scheme. The exemplary embodiment described with reference to FIG. 4 relates to 2D indexing for the sake of brevity, but 3D indexing may be possibly performed, and the principles of the present inventive concept may be extensively applied to various types of indexing in order to manage a reference relationship between images.

In an image indexing structure according to an exemplary embodiment, a respective 2D index is assigned to each of images 400, 401, 402, . . . , 415 of an image matrix 450. For example, index (0,0) is assigned to the root image 400, an instantaneous decoding refresh (IDR) image, and (i,j) type indexes are assigned to the other remaining images 401, 402, 403, . . . , 415. For a given index (i,j), i may designate a number of a row and j may designate the number of a column in the image matrix 450.

The respective images 400, 401, 402, . . . , 415 included in the image matrix 450 according to an exemplary embodiment may freely refer to other images, which have been already decoded, in the current image matrix 450. Further, a reference index list which includes indexes of pictures which can be referred to according to an I/P/B(b) prediction mode of the respective images 400, 401, 402, . . . , 415 may be previously defined. Still further, a reference index list which includes indexes of pictures which can be referred to according to a prediction mode arbitrarily set by a user may also be defined.

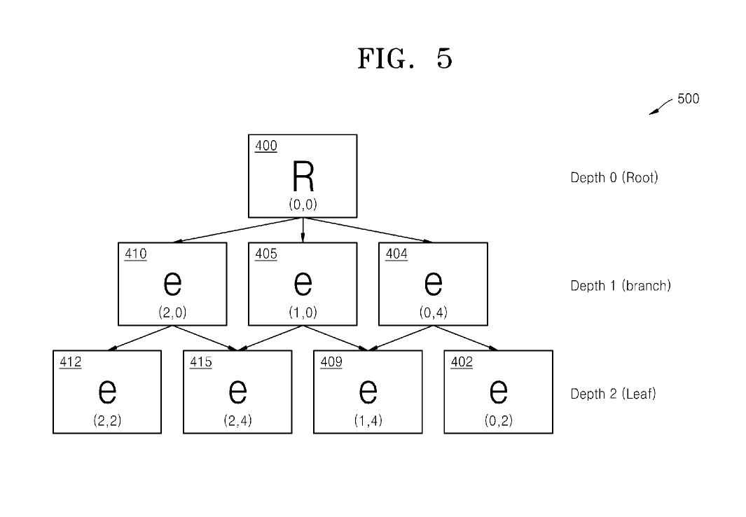

FIG. 5 shows an exemplary tree structure 500 according to a reference relationship relating to an image sequence, according to an exemplary embodiment.

The tree structure 500 may be configured according to a reference relationship for inter-image prediction in the image matrix 450. For example, depth 0, the uppermost level, in the tree structure 500 may be assigned to the root image 400, which is to be first encoded and decoded in the image matrix 450. The images 410, 405, and 404, each of which directly refers to the root image 400 of depth 0, may be determined to be depth 1. Further, images 412, 415, 409, and 402, each of which refers to at least one of the images 410, 405, and 404 of depth 1, may be determined as depth 2. In this manner, the tree structure 500 of depths 0, 1, 2, . . . may be configured according to the reference relationship for the inter-image prediction with respect to the image matrix 450.

The scalable video encoding apparatus 100, according to an exemplary embodiment, may encode parent image index information which indicates a parent image referred to by a current image, and may transmit the encoded parent image index information in conjunction with encoded image data. Further, the scalable video decoding apparatus 200, according to an exemplary embodiment, may analyze the tree structure 500 according to the reference relationship of the received images by using the parent image index information.

For example, the parent image index information, according to an exemplary embodiment, is set for each image, thereby indicating an index of a parent image of a current image. For example, parent image index information with respect to images constituting the tree structure 500 may be set as follows.

R(0, 0) 400: N/A

e(2,0) 410: Parent image is (0, 0) 400

e(1,0) 405: Parent image is (0, 0) 400

e(0,4) 404: Parent image is (0, 0) 400

e(2,2) 412: Parent image is (2, 0) 410

e(2,4) 415: Parent images are (2, 0) 410, (1, 0) 405

e(1,4) 409: Parent images are (1, 0) 405, (0, 4) 404

e(0,2) 402: Parent image is (0, 4) 404

In particular, the image 400 of index (0,0) is a root image of depth 0, without referring to a different image, so parent image index information is not set for the image 400.

Further, each of the image 410 of index (2,0), the image 405 of index (1,0), and the image 404 of index (0,4) of depth 1 is referred to only by the root image 400, and therefore, the corresponding parent image index information for each may be set to be index (0,0) of the root image 400.

Still further, because each of the image 412 of index (2,2), the image 415 of index (2,4), the image 409 of index (1,4), and image 402 of index (0,2) is referred to by images of depth 1, an respective index of a parent image referred to may be set as corresponding parent image index information. In particular, because the image 412 of index (2,2) is referred to by the image 410 of depth 1, the corresponding parent image index may be set to be (2,0). Because the image 415 of index (2,4) is referred to by images 410 and 405 of depth 1, the corresponding parent image index information may be set to be (2,0) (1,0). Because the image 409 of index (1,4) is referred to by the images 405 and 404 of depth 1, the corresponding parent image index information may be set to be (1,0) (0,4). Because the image 402 of index (0,2) is referred to by the image 404 of depth 1, the corresponding parent image index information may be set to be (0,4).

For inter-image prediction, the scalable video encoding apparatus 100, according to an exemplary embodiment, and the scalable video decoding apparatus 200, according to an exemplary embodiment, may respectively use a decoded image of a parent image as a reference image, or may respectively perform prediction encoding and decoding with respect to a current image by using only reference information relating to the parent image.

Further, the scalable video encoding apparatus 100, according to an exemplary embodiment, may determine whether the current image is to be prediction encoded or decoded by using which of a decoded restoration image of the parent image and reference information, predict accordingly, and encode an image sequence.

Still further, the scalable video encoding apparatus 100, according to an exemplary embodiment, may encode reference scheme information which indicates whether the current image is to be prediction encoded or decoded by using which of a decoded restoration image of the parent image and reference information, and transmit the encoded reference scheme information together with the encoded image data.

The scalable video decoding apparatus 200, according to an exemplary embodiment, may extract the reference scheme information from a received bit stream and perform prediction decoding with respect to the current image by using one of the decoded restoration image of the parent image and the reference information based on the extracted reference scheme information.

The prediction encoding or prediction decoding may be performed with reference to an ancestor image, a parent image of the parent image, and/or the parent image directly referred to by the current image, according to the structure 500.

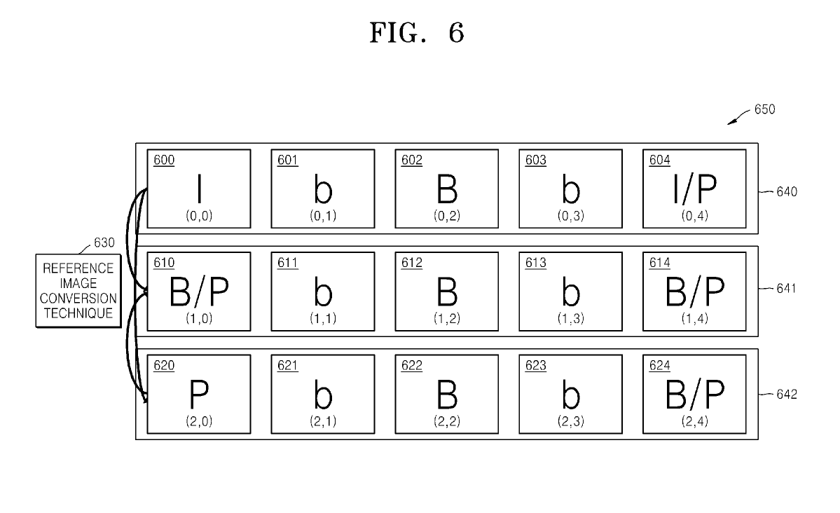

FIG. 6 illustrates a reference image conversion technique for use in performing inter-layer prediction with respect to an image sequence, according to an exemplary embodiment.

FIG. 6 illustrates an exemplary embodiment in which an image matrix 650 is classified into three layers, including an image group 640 of a 0^{th} layer, an image group 641 of a first layer, and an image group 642 of a second layer, by the layer classification unit 110 of the scalable video encoding apparatus 100 according to an exemplary embodiment. Accordingly, the image group 640 of the 0^{th} layer includes images 600, 601, 602, 603, and 604 of the image matrix 650, the image group 641 of the first layer includes images 610, 611, 612, 613, and 614 of the image matrix 650, and the image group 642 of the second layer includes images 620, 621, 622, 623, and 624 of the image matrix 650.

In relation to the indexing of the image matrix 650 according to an exemplary embodiment, i and j of an index (i,j) of an image respectively correspond to a layer number of the respective one of the image groups 640, 641, and 642 and a respective rank within an image order of the corresponding one of the image groups 640, 641, and 642. However, this is merely an example of image indexing, and the image indexing of the present disclosure is not necessarily limited to the combinations of the layer numbers and image order illustrated in FIG. 6.

The scalable video encoding apparatus 100, according to an exemplary embodiment, supports inter-layer prediction encoding, such that inter-layer prediction may be performed with respect to the images of the image group 640 of the 0^{th} layer, the image group 641 of the first layer, and the image group 642 of the second layer.

Further, in the intra-prediction encoding and inter-layer prediction encoding with respect to the image matrix 650 according to an exemplary embodiment, directional prediction modes of I/B/P pictures are defined, such the B picture or P picture refers to a different picture based on a prediction direction as between bi-directional prediction or forward directional prediction. In particular, similarly as described above with respect to the scalable video encoding scheme illustrated in FIG. 3, in the case of a picture of a different layer, there is no limitation of referring to a picture of the same POC. Thus, when performing the inter-layer prediction encoding according to an exemplary embodiment, in referring to images of a different layer, parent images may be determined based on the directional prediction modes of the I/B/P pictures regardless of the POC.

The scalable video encoding apparatus 100, according to an exemplary embodiment, may encode parent image index information which is set according to a reference relationship relating to scalable prediction encoding, and transmit the encoded parent image index information. Thus, parent image index information which indicates an index indicating a parent image to be used for prediction may be set for each of the images of the image group 640 of the 0^{th} layer, the image group 641 of the first layer, and the image group 642 of the second layer. Because the intra-prediction function, as well as the inter-prediction function, is available in the scalable video encoding apparatus 100, the parent image index information may include an index of a parent image of the same layer.

The scalable video decoding apparatus 200, according to an exemplary embodiment, may analyze a tree structure of the image matrix 650 based on parent image index information extracted by parsing a received bit stream, and search for a parent image for use in performing prediction decoding with respect to the current image.

The reference image generation unit 120, according to an exemplary embodiment, may convert the parent image of the current image into a reference image in order to generate a reference image for using in predicting the current image. By applying reference image conversion techniques 630 according to an exemplary embodiment, a plurality of reference images may be generated from a single parent image. For example, the reference image conversion techniques 630 may include a bypass technique, a scaling technique, an interlaced-progressive conversion technique, a color conversion technique, a filtering technique, a warping technique, a weight adding technique, an inter-layer interpolation technique, and the like.

In particular, by applying the bypass technique from among the reference image conversion techniques 630, a reference image which is the same as a parent image may be generated in order to refer to the parent image as it is. Conversely, by applying the scaling technique from among the reference image conversion techniques 630, a reference image obtained by reducing or magnifying the parent image may be generated.

By applying the interlaced-progressive conversion technique from among the reference image conversion techniques 630, a reference image obtained by converting a parent image based on an interlaced scheme into a parent image based on a progressive scheme may be generated, or a reference image obtained by converting a parent image based on the progressive scheme into a parent image based on the interlaced scheme may be generated and outputted.

By applying the color conversion technique from among the reference image conversion techniques 630, a reference image obtained by deforming a color component of a parent image may be generated. By applying the filtering technique from among the reference image conversion techniques 630, a reference image may be generated by applying a predetermined filter to a parent image. By applying the warping technique from among the reference image conversion techniques 630, a reference image obtained by warping a parent image may be generated and outputted. Further, by applying the weight adding technique from among the reference image conversion techniques 630, a reference image obtained by adding a predetermined weight to a parent image may be generated.

Still further, by applying the inter-layer interpolation technique from among the reference image conversion techniques 630, a reference image may be generated by interpolating parent images of the different layers.

The scalable video encoding apparatus 100, according to an exemplary embodiment, may encode information relating to the reference image conversion techniques 630 used by the respective images, and transmit the thusly encoded information.

The scalable video decoding apparatus 200, according to an exemplary embodiment, may parse a received bit stream to extract information relating to the reference image conversion technique 630. The reference image conversion unit 230 may determine the reference image conversion scheme 630 to be used with respect to a current image based on the extracted reference image conversion technique information, and convert a parent image found from first restored restoration images in the image matrix 650 by applying the reference image conversion technique 630 thereto, thus generating a reference image of the current image. The restoration unit 240 may perform intra-layer prediction/compensation or inter-layer prediction/compensation with respect to the current image by using the reference image to generate a restoration image of the current image.

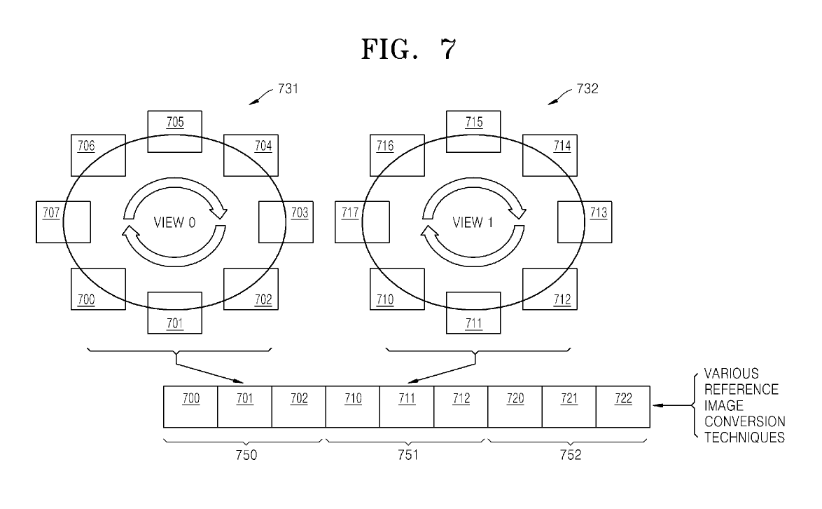

FIG. 7 illustrates an exemplary configuration of a reference image list, according to an exemplary embodiment.

The reference image generation unit 120, according to an exemplary embodiment, and the reference image conversion unit 230, according to an exemplary embodiment, may generate and manage a reference image list which includes various reference images generated from the parent image of the current image.

Layers of images of an image matrix illustrated in FIG. 7 are classified by view. In particular, images 700, 701, 702, 703, 704, 705, 706, and 707 of a 0^{th} view constitute an image group 731 of a 0^{th} layer; and images 710, 711, 712, 713, 714, 715, 716, and 717 of a first view constitute an image group 732 of a first layer. When a parent image of a current image includes at least one of images 700, 701, . . . , 706, 707, 710, 711, . . . , 716, and 717, reference images of the current image may be generated by using the parent image and included in a reference image list.

The reference image list, according to an exemplary embodiment, may be stored in at least one of the reference image generation unit 120 according to an exemplary embodiment and a memory of the reference image conversion unit 230 according to an exemplary embodiment. The reference images included in the reference image list may be periodically circulated to be stored in the memory.

For example, when the memory is divided into a first section 750, a second section 751, and a third section 752, some images 700, 701, and 702 of the image group 731 of the 0^{th} layer may be stored in the first section 750; some images 710, 711, and 712 of the image group 732 of the first layer may be stored in the second section 751; and some images 720, 721, and 722 of the image group of a different layer may be stored in the third section 752.

The images of the image group 731 of the 0^{th} layer, the image group 732 of the first layer, and the image group of the different layer may be stored in the memory based on a respective image order in each of the groups. Some of next images of the image group 731 of the 0^{th} layer, the image group 732 of the first layer, and the image group of the different layer may respectively be updated and stored in the first section 750, the second section 751, and the third section 752 based on a refresh period of the memory.

When the images of the image group 731 of the 0^{th} layer, the image group 732 of the first layer, and the image group of the different layer are stored in the memory, reference images which are generated upon being converted by applying various reference image conversion techniques according to an exemplary embodiment may also be stored. Thus, scalable prediction encoding or decoding may be performed by using the various reference images stored in the reference image list.

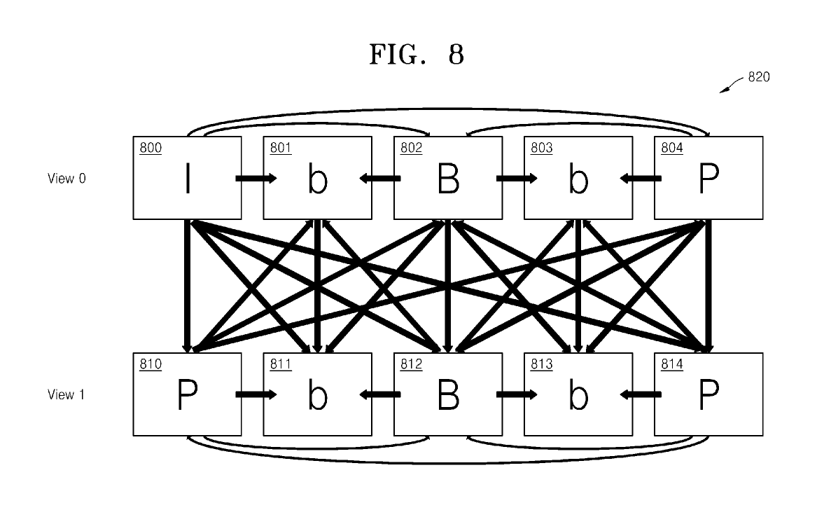

FIG. 8 illustrates a layer structure 820 of a stereo video which is configured for use in conjunction with an apparatus for scalable video encoding, according to an exemplary embodiment.

The scalable video encoding apparatus 100, according to an exemplary embodiment, may implement scalable video encoding in such a form in which layers are classified based on views, thereby producing a stereoscopic video profile.

Pictures 800, 801, 802, 803, and 804 of a 0^{th} view of a stereoscopic video may be classified as belonging to a 0^{th} layer, and pictures 810, 811, 812, 813, and 814 of a first view may be classified as belonging to a first layer.

According to the layer prediction structure 820 of FIG. 8, inter-layer prediction, as well as prediction between pictures in the same view, can be performed, such that prediction encoding may be performed on the pictures 800, 801, 802, 803, and 804 of the 0th view and the pictures 810, 811, 812, 813, and 814 of the first view with reference to pictures of different views.

Prediction encoding may be performed with respect to the current image with reference to a reference image obtained by converting a picture of a different view as a reference subject by applying a reference image conversion technique.

The scalable video decoding apparatus 200, according to an exemplary embodiment, may determine a parent image of the same view or a different view as being the corresponding parent image of the respective current image, and the apparatus 200 may also select a reference image conversion technique based on parent image index information and reference image conversion technique information.

Accordingly, a reference image of the same view or a different view for the current image may be determined, and intra-layer prediction decoding or inter-layer prediction decoding may be performed with respect to the current image to generate a restoration image of the current image.

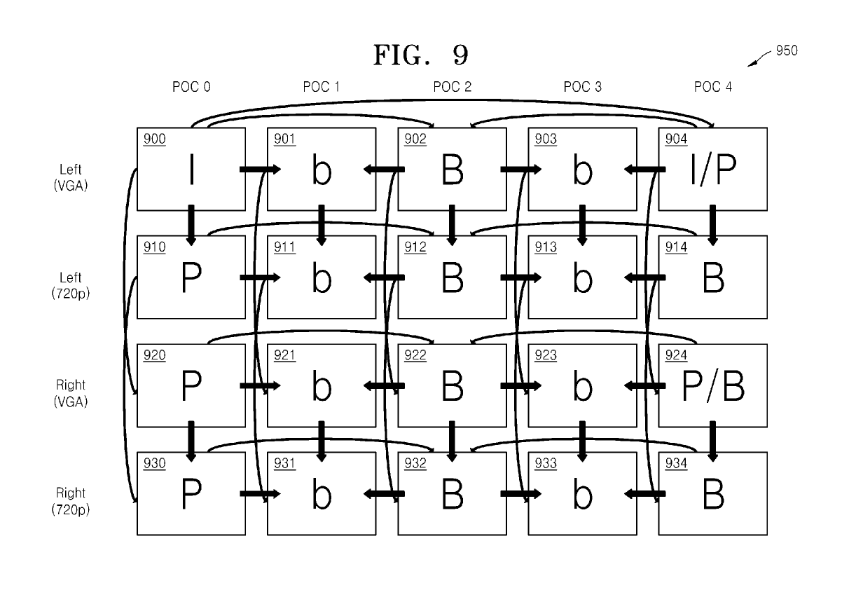

FIG. 9 shows a layer structure 950 of a multiview video which is configured for use in conjunction with an apparatus for scalable video encoding, according to an exemplary embodiment.

The scalable video encoding apparatus 100, according to an exemplary embodiment, may implement scalable video encoding in such a form in which layers are classified based on the resolution of each view, thereby producing a multiview video profile.

The scalable video encoding apparatus 100, according to an exemplary embodiment, may classify left view pictures and right view pictures of a multiview video as belonging to one of pictures of VGA-class resolution and pictures of 720 p resolution, and constitute respective layers based on the corresponding classifications.

In particular, VGA-class pictures 900, 901, 902, 903, and 904 of a left view are classified as belonging to a 0th layer, and 720 p-class pictures 910, 911, 912, 913, and 914 of the left view may be classified as belonging to a first layer. Further, VGA-class pictures 920, 921, 922, 923, and 924 of a right view may be classified as belonging to a second layer, and 720 p-class pictures 930, 931, 932, 933, and 934 of the right view may be classified as belonging to a third layer.

In accordance with the layer prediction structure 950 of FIG. 9, because inter-layer prediction, as well as prediction encoding between pictures of the same view and same resolution, can be performed, the VGA-class pictures 900, 901, 902, 903, and 904 of the left view, the 720 p-class pictures 910, 911, 912, 913, and 914 of the left view, the VGA-class pictures 920, 921, 922, 923, and 924 of the right view, and the 720 p-class pictures 930, 931, 932, 933, and 934 of the right view may be prediction-encoded with reference to pictures of different views or pictures of different resolutions.

Because the pictures of different views or different resolutions can be converted into a reference image by applying a reference image conversion technique, prediction encoding may be performed with respect to the current image by using the reference image obtained by converting a picture of a different view or a picture of a different resolution.

As indicated by arrows, the layer prediction structure 950 of FIG. 9 includes reference relationships in which pictures refer to an image of the same resolution of a different view or refer to an image of a different resolution of the same view, but does not include any reference relationship in which pictures refer to an image of a different resolution of a different view. However, because the resolution of a parent image can be converted to be the same as that of the respective current image based on the selection of the scaling technique from among the reference image conversion techniques, the prediction structure 950 for the scalable video encoding of a multiview video according to an exemplary embodiment may include a reference relationship in which pictures refer to an image of a different resolution and of a different view.

The scalable video decoding apparatus 200, according to an exemplary embodiment, may determine a parent image of the same view or different view as that of the respective current image, or a parent image of the same resolution or a different resolution as that of the respective current image, and may also determine a reference image conversion technique based on the corresponding parent image index information and the reference image conversion technique information.

Accordingly, a reference image of the same view or a different view or the same resolution or a different resolution for the current image may be determined, and inter-layer or intra-layer prediction decoding may be performed with respect to the current image based on the determined reference image to generate a restoration image of the current image.

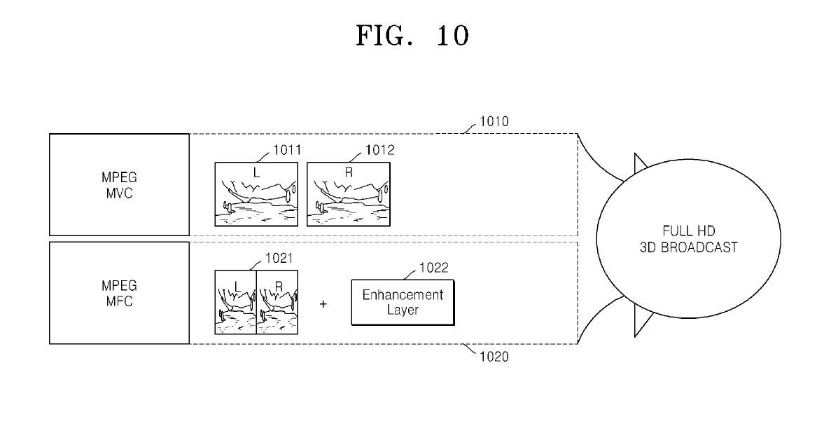

FIG. 10 illustrates an incorporation of an MVC scheme and an MPEG frame compatible (MFC) scheme by an apparatus for scalable video encoding and decoding, according to an exemplary embodiment.

An MVC bit stream 1010 which is encoded according to an MVC scheme includes a bit stream 1011 in which a left view video has been encoded and a bit stream 1012 in which a right view video has been encoded, by encoding a stereoscopic video based on views.

An MFC bit stream 1020 which is encoded according to an MFC scheme includes a basic layer bit stream 1021 and an enhancement layer bit stream 1022 which has been encoded by synthesizing a left view video and a right view video into a single video. The MFC scheme may perform encoding hierarchically based on resolution.

The layer classification unit 110 of the scalable video encoding apparatus 100 according to an exemplary embodiment does not limit or restrict a selection of a condition upon which a layer classification is performed, so the layer classification unit 110 can freely determine the classification condition. Thus, the scalable video encoding apparatus 100, according to an exemplary embodiment, may transmit the bit stream 1021 of the basic layer and the bit stream 1022 of the enhancement layer which have been encoded by classifying layers based on resolution, while simultaneously transmitting the encoded bit stream 1011 of the left view video and the bit stream 1012 of the right view video, which have been encoded by classifying layers based on views.

Thus, the scalable video decoding apparatus 200, according to an exemplary embodiment, can decode bit streams of various layers which are received from the scalable video encoding apparatus 100, according to an exemplary embodiment, to restore videos of various formats and to restore a video having the same resolution as that of the original video. In this aspect, a 3D broadcast service of a particular format may be selectively provided, based on a user request or a system request, while a 3D broadcast service of full resolution is also being provided.

Thus, the video services which are provided in different formats which respectively correspond to each of the existing standards can be unified by the scalable video encoding apparatus 100 according to an exemplary embodiment and the scalable video decoding apparatus 200 according to an exemplary embodiment, whereby multiview video services of various formats may be integrated together and provided, and 3D video services may be provided in full resolution. Further, a video service having a format desired by the user can be freely selected and received, and a video of full resolution can also be freely selected and received.

FIG. 11 is a flowchart which illustrates a process to be performed by an apparatus for scalable video encoding, according to an exemplary embodiment.

In operation 1110, at least one root image and the other remaining images of an image sequence of an input video are classified into a plurality of layers. An image sequence of a multiview video which includes a 2D video or a 3D video may be inputted into an apparatus for scalable video encoding, according to an exemplary embodiment. The current image sequence is classified into a plurality of layers based on a particular reference and encoded by layer. For example, layers of an image sequence which includes images of a plurality of views and a plurality of resolutions may be classified by view and resolution.

In operation 1120, at least one reference image with respect to a current image is generated by applying a reference image conversion technique for scalable prediction encoding to a parent image of the current image. The reference image conversion technique, according to an exemplary embodiment, may include one or more conversion techniques. Thus, various reference image conversion techniques can be applied to a single parent image of the current image to generate at least one reference image for the current image. The plurality of reference images may be stored as a reference image list and managed accordingly.

In operation 1130, prediction encoding may be performed with respect to the current image by using at least one reference image. Based on a tree structure according to a reference relationship relating to the image sequence, parent image index information which indicates a corresponding parent image may be encoded with respect to respective images of the image sequence. Further, information relating to the reference image conversion technique applied to generate the reference image for the current image may be encoded.

Through inter-layer prediction and intra-layer prediction performed with respect to the image sequence, an encoded bit stream of the image may be transmitted together with the parent image index information and the reference image conversion technique information.

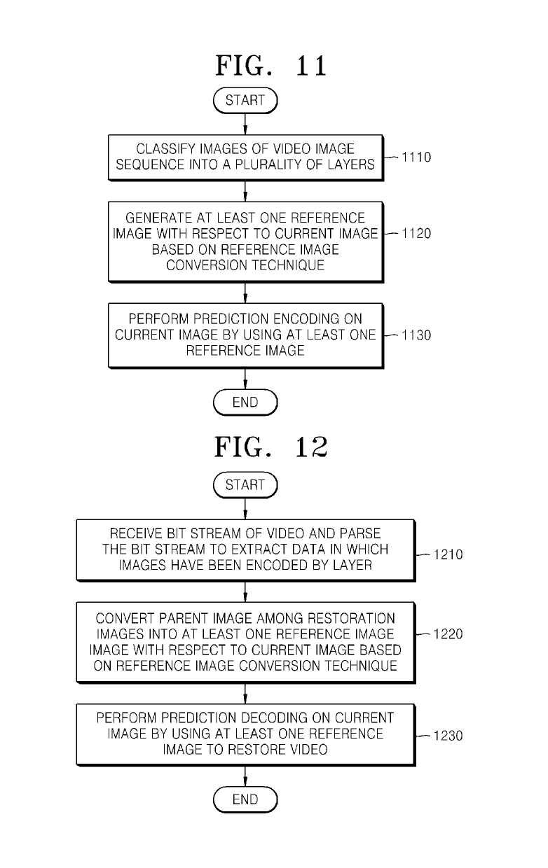

FIG. 12 is a flowchart which illustrates a process to be performed by using an apparatus for scalable video decoding, according to an exemplary embodiment.

In operation 1210, a bit stream of a video is received and parsed to extract data in which at least one root image and the other remaining images of an image sequence of the video are classified into a plurality of layers and encoded. Parent image index information and reference image conversion technique information may be extracted from the bit stream together with the encoded bit stream of the image. The encoded data of the image sequence which is extracted from the bit stream of the video may be decoded to restore residual information and reference information relating to the image sequence.

In operation 1220, by applying a reference image conversion technique for scalable prediction decoding, a parent image from among the restoration images of the image sequence may be converted into at least one reference image with respect to a current image. A reference image of the same layer may be used for intra-layer prediction decoding, and a reference image of a different layer may be used for inter-layer prediction decoding.

A tree structure according to a reference relationship of the image sequence is recognized based on the parent image index information extracted in operation 1210, such that the parent image which corresponds to the respective current image may be searched for and determined from the restoration images included in the image sequence. Further, based on the reference image conversion technique information extracted in operation 1210, a reference image for the current image may be generated by applying the reference image conversion technique to the parent image. A plurality of reference images may be generated by applying a plurality of reference image conversion techniques. The plurality of reference images may be stored in a reference image list, and updated and managed.

In operation 1230, prediction decoding is performed with respect to the current image by using at least one reference image. For example, based on a scalable video decoding method according to an exemplary embodiment, the multiview video which includes a 2D video or a 3D video is restored by layer, and in this case, images sequences of different resolutions in each view may be restored while the respective image sequences are being restored by view.

Thus, according to the scalable video encoding method according to at least one exemplary embodiment and the scalable video decoding method according to at least one exemplary embodiment, a 2D video or a 3D video is encoded by layer according to various formats and transmitted, thus implementing a multiview video service providing 2D video content or 3D video content in various formats. Further, because inter-layer prediction and intra-layer prediction can be performed, compression efficiency can be improved to allow for effective compression of the multiview video of the 2D video content or the 3D video content.

The block diagrams described above may be construed by a skilled person in the art as disclosing a form conceptually expressing circuits for implementing principles relating to the present inventive concept. Similarly, it will be understood by a skilled person in the art that a certain flowchart, a flowchart, a status transition view, a pseudo-code, or the like, may be substantially expressed as a set of instructions which is stored in a computer-readable medium to denote various processes which can be executed by a computer or a processor, regardless of whether or not the computer or the processor is specified with particularity. Thus, the foregoing exemplary embodiments may be created as programs which can be executed by computers and may be implemented in a general digital computer which operates the programs by using a computer-readable recording medium. The computer-readable recording medium may include, for example, storage mediums such as a magnetic storage medium (e.g., a ROM, a floppy disk, a hard disk, or the like), an optical reading medium (e.g., a CD-ROM, a DVD, or the like).

Functions of various elements illustrated in the drawings may be provided by the use of dedicated hardware as well as by hardware which is related to appropriate software and can execute the software. When provided by a processor, such functions may be provided by a single dedicated processor, a single shared processor, or a plurality of individual processors which can share some of the functions. Further, the stated use of terms “processor” or “controller” should not be construed to exclusively designate hardware which can execute software, and may tacitly include, for example, digital signal processor (DSP) hardware, a ROM for storing software, a RAM, and a non-volatile storage device, without any limitation.

In the claims, elements expressed as units for performing particular functions may cover a certain method performing a particular function, and such elements may include a combination of circuit elements performing particular functions, or software in a certain form including firmware, microcodes, or the like, combined with appropriate circuits to perform software for performing particular functions.

Designation of “an exemplary embodiment” of the principles of the present inventive concept, and various modifications of such an expression, may mean that particular features, structures, characteristics, and the like, in relation to this exemplary embodiment are included in at least one exemplary embodiment of the principle of the present inventive concept. Thus, the expression “an exemplary embodiment” and any other modifications disclosed throughout the entirety of the present disclosure may not necessarily designate the same exemplary embodiment.

In the present specification, in a case of “at least one of A and B,” the expression of “at least one among˜” is used to cover only a selection of a first option (A), only a selection of a second option (B), or a selection of both options (A and B). As another example, in the case of “at least one of A, B, and C,” the expression of “at least one among˜” is used to cover only a selection of a first option (A), only a section of a second option (B), only a selection of a third option (C), only a selection of the first and second options (A and B), only a selection of the second and third options (B and C), or a selection of all of the three options (A, B, and C). Even when more items are enumerated, it will be understood by a skilled person in the art that the possible selections of options can be definitely extendedly construed.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

1. A method for scalable video encoding, the method comprising:
classifying at least one root image and other remaining images of an image sequence of a video into a plurality of layers;
generating at least one reference image relating to a current image of the image sequence by applying a reference image conversion technique for scalable prediction encoding which includes intra-layer prediction and inter-layer prediction to a parent image of the current image; and
performing prediction encoding with respect to the current image by using the at least one reference image.

2. The method of claim 1, further comprising:
encoding parent image index information which indicates a respective parent image referred to by each of the images of the image sequence based on a tree structure according to a reference relationship relating to the image sequence.

3. The method of claim 1, wherein the video includes at least one of a two-dimensional video and a three-dimensional video, and the classifying of the at least one root images and the other remaining images of the image sequence into a plurality of layers includes classifying the image sequence based on at least one image characteristic.

4. The method of claim 3, wherein the at least one image characteristic comprises a view and a resolution of a multiview image.

5. The method of claim 1, wherein the performing prediction encoding with respect to the current image comprises:
determining which one of a restoration image of the parent image and reference information is to be referred to for the prediction encoding; and
predicting the current image with reference to one of the restoration image of the parent image and the reference information based on the determination.

6. The method of claim 5, further comprising:
encoding information which indicates whether or not any one of information indicating the corresponding parent image with respect to the current image, the restoration image of the parent image, and the reference information is to be referred to, based on a tree structure according to a reference prediction relationship between the current image and the corresponding parent image.

7. The method of claim 1, wherein the reference image conversion technique comprises at least one of a bypass technique, a scaling technique, an interlaced-progressive conversion technique, a color conversion technique, a filtering technique, a warping technique, a weight adding technique, and an inter-layer interpolation technique, and
the generating of the at least one reference image comprises applying the reference image conversion technique to a single parent image.

8. The method of claim 7, wherein the generating of the at least one reference image comprises generating a reference image list which includes at least one reference image generated by using the reference image conversion technique with respect to the current image, and
the performing prediction encoding comprises performing prediction encoding with respect to the current image with reference to at least one image stored in the reference image list.

9. The method of claim 8, further comprising:
updating the generated reference image list by selecting a new current image, determining a corresponding new parent image with respect to the selected new current image, and applying the reference image conversion technique to the corresponding new parent image, and managing the updated generated reference image list.

10. The method of claim 7, further comprising:
encoding information which indicates the reference image conversion technique.

11. A method for scalable video decoding, the method comprising:
extracting data from a bit stream of a video in which data at least one root image and other remaining images of an image sequence of the video are classified into a plurality of layers and encoded;
converting a parent image from among restoration images of the image sequence into at least one reference image with respect to a current image by applying a reference image conversion technique for scalable prediction decoding which includes intra-layer prediction and inter-layer prediction to the parent image; and
performing prediction decoding with respect to the current image by using the at least one reference image.

12. The method of claim 11, wherein the extracting of data comprises extracting parent image index information which indicates a corresponding parent image to be referred to by each respective one of the images of the image sequence, from the bit stream, and
the converting of the parent image into the at least one reference image comprises analyzing a tree structure according to a reference relationship relating to the image sequence based on the extracted parent image index information, and using a result of the analyzing to determine the parent image which corresponds to the current image.

13. The method of claim 11, wherein the video includes at least one of a two-dimensional video and a three-dimensional video, and the layers of the image sequence are classified based on at least one image characteristic.

14. The method of claim 13, wherein the at least one image characteristic comprises a view and a resolution of a multiview image.

15. The method of claim 12, wherein the extracting of data comprises extracting reference subject information which indicates whether or not any one of a restoration image relating to the parent image and reference information is to be referred to for the prediction-decoding with respect to the current image.

16. The method of claim 15, wherein the performing prediction decoding with respect to the current image comprises extracting reference subject information which indicates whether or not any one of the restoration image relating to the parent image and the reference information is to be referred to for the prediction decoding with respect to the current image.

17. The method of claim 11, wherein the reference image conversion technique comprises at least one of a bypass technique, a scaling technique, an interlaced-progressive conversion technique, a color conversion technique, a filtering technique, a warping technique, a weight adding technique, and an inter-layer interpolation technique,
and the converting of the parent image into the at least one reference image comprises applying the reference image conversion technique to a single parent image.

18. The method of claim 17, wherein the converting of the parent image into the at least one reference image comprises generating a reference image list which includes at least one reference image generated by using the reference image conversion technique with respect to the current image, and
the performing prediction decoding with respect to the current image comprises performing prediction decoding with respect to the current image with respect to at least one image stored in the reference image list.

19. The method of claim 18, further comprising:
updating the generated reference image list by selecting a new current image, determining a corresponding new parent image with respect to the selected new current image, and applying the reference image conversion technique to the corresponding new parent image, and managing the updated generated reference image list.

20. The method of claim 17, wherein the converting of the parent image into the at least one reference image comprises:
extracting information which indicates the reference image conversion technique; and
generating the at least one reference image from the single parent image based on the extracted information which indicates the reference image conversion technique.

21. The method of claim 11, further comprising:
decoding the encoded data of the image sequence extracted from the bit stream of the video; and
outputting residual information and reference information relating to the image sequence based on a result of the decoding.

22. An apparatus for scalable video encoding, the apparatus comprising:
a layer classification unit which classifies at least one root image and other remaining images of an image sequence of a video into a plurality of layers;
a reference image generation unit which generates at least one reference image with respect to a current image of the image sequence by applying a reference image conversion technique for scalable prediction encoding which includes intra-layer prediction and inter-layer prediction to a parent image of the current image;
a prediction encoding unit which performs prediction encoding with respect to the current image by using the at least one reference image; and
an output unit which performs transformation, quantization, and entropy encoding on data relating to the encoded current image, and which outputs an encoded bit stream and parent image index information which indicates the parent image of the current image.

23. An apparatus for scalable video decoding, the apparatus comprising:
an extraction unit which extracts data from a bit stream of a video in which data at least one root image and other remaining images of an image sequence of the video are classified into a plurality of layers and encoded;
a decoding unit which decodes the extracted encoded data and which outputs residual information and reference information relating to the image sequence;
a reference image conversion unit which converts a parent image from among restoration images of the image sequence into at least one reference image with respect to a current image by applying a reference image conversion technique for scalable prediction decoding which includes intra-layer prediction and inter-layer prediction to the parent image; and
a restoration unit which performs prediction decoding with respect to the current image by using the at least one reference image and the outputted reference information and the outputted residual information.

24. A non-transitory computer-readable recording medium comprising a program for implementing the method for scalable video encoding of claim 1.

25. A non-transitory computer-readable recording medium comprising a program for implementing the method for scalable video decoding of claim 11.

26. A method for performing video encoding with respect to a first image which is selected from among a plurality of images included in an image sequence and which has a parent image which is included within the plurality of images, the method comprising:
generating at least one reference image relating to the first image by applying a reference image conversion technique to the parent image of the first image; and
performing prediction encoding with respect to the first image by using the at least one reference image.

27. (canceled)

28. The method of claim 26, wherein each of the plurality of images is classified based on a characteristic view and a characteristic resolution, and wherein each of the at least one reference image and the first image has a same view, and wherein the at least one reference image has a different resolution than the first image.

29. The method of claim 26, wherein each of the images included in the plurality of images is classified based on a characteristic view and a characteristic resolution, and wherein each of the at least one reference image and the first image has a same resolution, and wherein the at least one reference image has a different view than the first image.

30. The method of claim 26, wherein each of the images included in the plurality of images is classified based on a characteristic view and a characteristic resolution, and wherein each of the at least one reference image has a different view than the first image, and wherein the at least one reference image has a different resolution than the first image.

31. A method for performing video decoding with respect to a first image which is selected from among a plurality of images included in an image sequence and which has a parent image which is included within the plurality of images, the method comprising:
converting the parent image of the first image into at least one reference image with respect to the first image by applying a reference image conversion technique to the parent image; and
performing prediction decoding with respect to the first image by using the at least one reference image.

32. The method of claim 31, wherein each of the images included in the plurality of images is classified based on a characteristic view and a characteristic resolution, and wherein each of the at least one reference image and the first image has a same view, and wherein the at least one reference image has a different resolution than the first image.

33. The method of claim 31, wherein each of the images included in the plurality of images is classified based on a characteristic view and a characteristic resolution, and wherein each of the at least one reference image and the first image has a same resolution, and wherein the at least one reference image has a different view than the first image.

34. The method of claim 31, wherein each of the images included in the plurality of images is classified based on a characteristic view and a characteristic resolution, and wherein each of the at least one reference image has a different view than the first image, and wherein the at least one reference image has a different resolution than the first image.
